(19) United States
(12) Patent Application Publication
(10) Pub. No.: US 2008/0103253 A1
(43) Pub. Date: May 1, 2008

(54) Process for Preparing S-Pvc

(76) Inventors: Mario Berna, Bologna (IT); Adriano Ambu, Bologna (IT); Roberto Mandini, Malalbergo (IT); Lisa Dibona, S. Pietro In Casale (IT)

Correspondence Address: STETINA BRUNDA GARRED & BRUCKER, 75 ENTERPRISE, SUITE 250, ALISO VIEJO, CA, 92656, US

(21) Appl. No.: 11/883,436

(22) PCT Filed: Feb. 6, 2006
(86) PCT No.: PCT/EP06/50679

§ 371 Date: Jul. 31, 2007

(30) Foreign Application Priority Data
Feb. 4, 2005 (IT) MI2005A000155

(51) Int. Cl. C08L 27/06

(52) U.S. Cl. 524/803

(57) ABSTRACT

The present invention relates to a new process for preparing PVC in aqueous suspension wherein the polymerisation reaction of monovinyl chloride is conducted in the presence of: a) a suspending system A comprising at least one polyvinyl alcohol having a hydrolysis degree between 25% and 98%, an acrylic polymer and, optionally, a polymeric plasticizer; and b) a suspending system B comprising at least one polyvinyl alcohol having a hydrolysis degree between 25% and 70% and a hydrotalcite compound.

### FIELD OF THE INVENTION

The present invention relates to a new process for aqueous suspension polymerisation which enables a polyvinyl chloride having optimum thermal stability and excellent morphological characteristics to be obtained.

### STATE OF THE ART

The polymerisation of vinyl chloride in suspension is a much used process for preparing PVC (S-PVC) in that; compared with other polymerisation techniques (for example mass and emulsion techniques), it enables to obtain less impurities inside the final polymer and requires more simple post-polymerisation treatments. With the aim of enabling effective dispersion of the monomer in water and of preventing agglomeration of the water-insoluble polymer particles, the polymerisation reaction in suspension always requires the use of suspending agents which have significant effects both on the dispersibility of the monomer in the reaction medium and on the morphology of the polyvinyl chloride particles obtained.

The addition of hydrotalcite type compounds to halogenated resins with the aim of providing thermal stability thereto is known in the art.

In addition, a process is described in patent U.S. Pat. No. 4,710,551 for preparing S-PVC wherein the polymerisation reaction is conducted using as suspending agents hydrotalcite type compounds, preferably coated with colloidal silica or with anionic surface active agents, possibly in association with traditional primary suspending agents. In particular, in the experimental examples of the patent, polymerisation trials are described which are conducted in 3 litre autoclaves using as the reaction medium water in which a hydrotalcite compound is dispersed.

The aforesaid patent confirms that the process described therein enables a final S-PVC having high heat stability to be obtained.

The present inventors have tried to reproduce the process described in U.S. Pat. No. 4,710,551 and have found that the mixing of hydrotalcite compounds, water and vinyl chloride monomer is only mechanical. Therefore, contrary to that described in the patent, the hydrotalcite compounds, even if surface treated, do not act as suspending agents.

In addition, the present inventors have also found that the process in U.S. Pat. No. 4,710,551 is not usable for preparing S-PVC not even in the presence of traditional suspending agents in that the hydrotalcite compounds prove to be incompatible with traditional suspending agents and the addition of these compounds can cause the suspending system itself to collapse.

A further limit to the use of the process of U.S. Pat. No. 4,710,551 in industrial manufacture of S-PVC is the fact that in said process, in order to obtain an effective dispersion of hydrotalcite, which is present in substantial amounts and is insoluble in water, vigorous agitation of the mixture is necessary, which results in foaming during the polymerisation reaction, a problem that is well known to the skilled man.

Moreover, not withstanding patent U.S. Pat. No. 4,710,551 asserts that PVC obtained by the method described therein possesses considerable stability, the hydrotalcite compounds used in the process of said patent are not compatibilized but are simply added to the polymer hence achieving a stabilization which is analogous to that obtained by adding hydrotalcite to the preformed polymer. The quantity of hydrotalcite used in the process is considerable in order to be certain that at least in some way it mixes with the PVC produced, while the more substantial part is lost in the filtration and washing process of the polymer.

Finally, if the process is implemented as described in the patent examples, i.e. in the absence of secondary suspending agents to regulate the porosity of the vinyl chloride monomer bubbles, it does not enable a polymer to be obtained with the morphology (i.e. porosity, apparent density, Fish-eyes numbers etc.) that conforms to the quality commonly required by the market. Indeed it is known that, in the absence of suspending system, the vinyl chloride monomer polymerisation reaction results in the synthesis of polymers with morphology problems, rendering them unusable for normal applications.

Therefore, since the hydrotalcite compound is not incorporated uniformly in the polymer, the stabilizing properties which characterise it are also not effectively exploited. The problem remains therefore of achieving intimate interaction between the hydrotalcite compound and the growing PVC particles via the uniform dispersion of the hydrotalcite compound during the polymerisation reaction so as to confer stabilizing properties on the resin.

### SUMMARY OF THE INVENTION

The present inventors have now found that the aforesaid problems can be solved by conducting the vinyl chloride monomer polymerisation reaction in the presence of specific modified suspending systems, instead of traditional primary and secondary suspending systems, in association with hydrotalcite compounds.

The present invention therefore relates to a process for preparing S-PVC in aqueous suspension in which the polymerisation reaction of the vinyl chloride monomer is conducted in the presence of:

a) a suspending system A comprising at least one polyvinyl alcohol having a degree of hydrolysis between 25% and 98%, an acrylic polymer and, optionally, a polymeric plasticizer; and

b) a suspending system B comprising at least one polyvinyl alcohol having a degree of hydrolysis between 25% and 70% and a hydrotalcite compound.

The present invention also relates to compositions for preparing the aforesaid suspending systems A and B and to their use in the preparation of S-PVC.

### DETAILED DESCRIPTION OF THE FIGURES

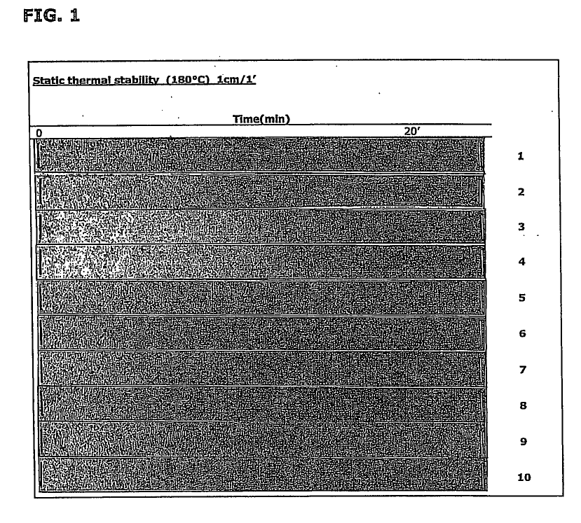

FIG. 1: shows the results obtained in the static thermal stability test undertaken in Example 4, represented as colour variations as a function of time for samples prepared with mixes having the composition indicated in table 6.

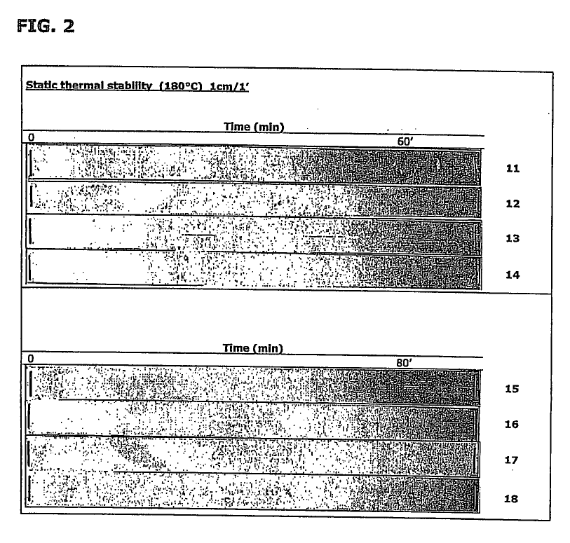

FIG. 2: shows the results obtained in the static thermal stability test carried out in Example 5, represented as colour variations as a function of time for samples prepared with mixes having the composition indicated in table 8.

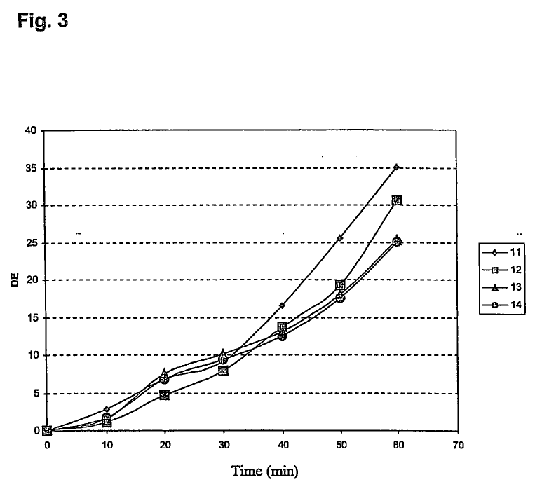

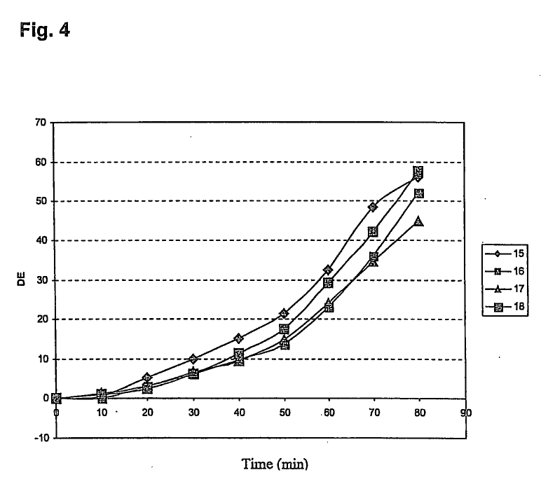

FIG. 3 and FIG. 4: results of the static thermal stability test carried out in Example 5 expressed as numerical values by way of the parameter DE representing the chromatic difference in colorimetric space between the initial state and the state detected at intervals of 10 minutes, of samples prepared with mixes having the composition indicated in table 8.

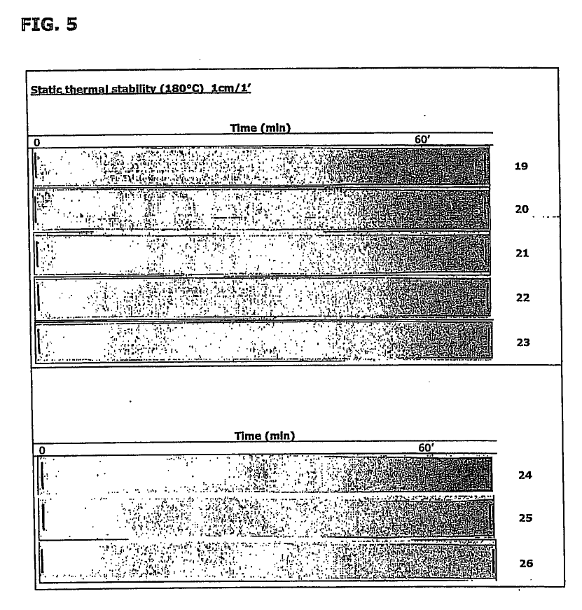

FIG. 5: shows the results of the static thermal stability test carried out in Example 7, represented as variation in colour as a function of time, of samples prepared with mixes having the composition indicated in table 10.

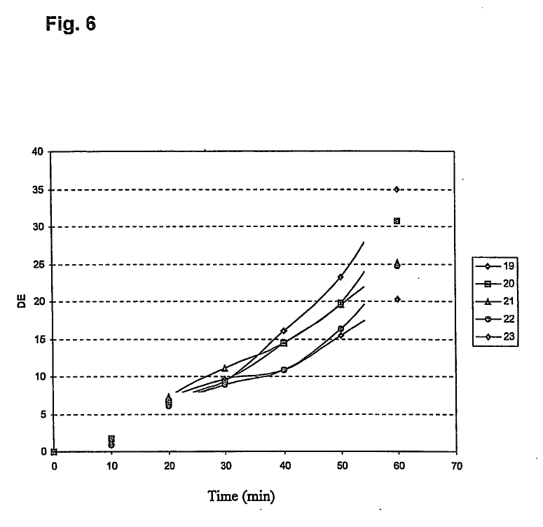

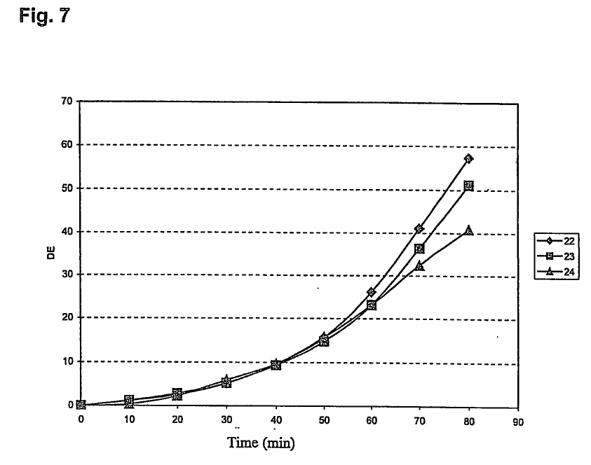

FIG. 6 and FIG. 7: show the results of the static thermal stability test carried out in Example 7 and expressed as numerical values by way of the parameter DE representing the chromatic difference in the calorimetric space between the initial state and the state detected at intervals of 10 minutes.

### DETAILED DESCRIPTION OF THE INVENTION

The present invention provides a process for preparing S-PVC in aqueous suspension wherein polymerisation of monovinyl chloride is conducted in the presence of the following suspending systems:

a) a suspending system A, comprising at least one polyvinyl alcohol having a degree of hydrolysis between 25% and 98%, preferably between 70% and 90%, and an acrylic polymer. Preferably, said suspending system also comprises a polymeric plasticizer; and

b) a suspending system B comprising at least one polyvinyl alcohol having a degree of hydrolysis between 25% and 70%, preferably between 35% and 55% and even more preferably between 40% and 50%, and a hydrotalcite compound of formula (I):
[M²⁺₁₋ₓM³⁺ₓ(OH)]^{x+}(Aⁿ⁻_{x/n}).mH₂O (1)
wherein:
M²⁺ represents at least one divalent metal cation selected from the group consisting of Mg, Ca, Sr, Ba, Zn, Co, Mn and Ni;
M³⁺ represents at least one trivalent metal cation selected from the group consisting of Al, B, Bi and Fe;
Aⁿ⁻ is an anion having a valency from 1 to 4;
x and m represent positive numbers satisfying the following expressions
0.2<x≦0.33
m>0.

The primary function of aforesaid suspending system A is that of regulating the average particle size distribution of the PVC particles to be obtained. The primary function of aforesaid suspending system B is instead that of controlling porosity of the PVC particles to be obtained.

The present inventors have found that, in order for the hydrotalcite compounds to be carried inside the aforesaid suspending system A, it is necessary that said compounds are first subjected to treatment with a protic polar solvent, preferably an alcohol, even more preferably selected from the group consisting of methanol, ethanol, propanol and isopropanol, and they are then suspended in the presence of a specific suspending agent, consisting of polyvinyl alcohol with a degree of hydrolysis between 25% and 70%, thus obtaining a suspending system B containing the hydrotalcite type compound.

The suspending system B, containing the quantity of stabilizer most convenient to achieve the desired stabilization, is then added to the suspending system A.

Therefore, in accordance with a particularly preferred embodiment, the process of the invention comprises the following steps:

I) treating with an alcohol the aforesaid hydrotalcite compound in aqueous suspension obtained by the hydrothermal treatment synthesis, under stirring and at ambient temperature, then filtering the mixture to obtain a paste consisting of a hydrotalcite compound in a hydroalcoholic solution. The amount of hydrotalcite type compound in said paste is preferably of 25-35% by weight and even more preferably of 27-32% by weight;

II) adding (under stirring) the paste derived from step I) to a solution of polyvinyl alcohol in methanol with a degree of hydrolysis between 25% and 70%, said solution having a concentration of preferably between 20% and 60%, thus obtaining the aforesaid suspending system B. Preferably, the suspending system B obtained contains between 7% and 18% of hydrotalcite compound and between 5% and 15% of polyvinyl alcohol.

III) adding, under stirring, the suspending system B obtained in step II) to the aforesaid suspending system A having a polyvinyl alcohol concentration preferably between 2% and 8% and even more preferably between 3% and 5%.

The suspension described in step II) can also be used after stripping of the liquids but treatment in suspension is preferable for easier use of the system particularly in the dosing stage.

Preferably, the polymerisation process of the present invention is conducted in the presence of a concentration, expressed in parts per million with respect to the amount of vinyl chloride monomer, between 400 and 1500 ppm of said polyvinyl alcohol of suspending system A, between 600 and 1800 ppm of said polyvinyl alcohol of suspending system B and between 500 and 2500 ppm of said hydrotalcite compound of formula 1).

Even more preferably, the process of the present invention is conducted in the presence of a concentration between 600 and 1000 ppm of said polyvinyl alcohol of suspending system A, between 600 and 1200 ppm of said polyvinyl alcohol of suspending system B and between 800 and 1400 ppm of said hydrotalcite compound of formula 1).

In the process of the present invention the suspending system A, compared to traditional primary suspending systems, has been rendered compatible with the hydrotalcite compound by the addition of an acrylic polymer and, optionally, a polymeric plasticizer.

Therefore, a further aspect of the present invention is a powder composition suitable for preparing suspending system A comprising:

a) from 60% to 90% of at least one polyvinyl alcohol having a degree of hydrolysis between 25 and 98%; and

b) from 2% to 15% of an acrylic polymer.

According to a particularly preferred embodiment said composition also comprises a polymeric plasticizer, in a quantity preferably between 2% and 10% and preferably between 3% and 5%.

According to a further aspect, the present invention also relates to a suspending system, the aforesaid suspending system A, obtained by dissolving the aforesaid composition in water.

The components of the aforesaid composition and of the aforesaid suspending system will be better characterised hereinafter.

1) Polyvinyl Alcohols

The term “polyvinyl alcohol” or “PVA” refers to “vinyl-acetate-vinyl alcohol copolymers”, a broad class of compounds used as suspending agents in the process of suspension polymerisation of PVC. In the present invention polyvinyl alcohols are used having a degree of hydrolysis between 25% and 98%. Particularly preferred among the polyvinyl alcohols that can be used for the purposes of the present invention, are those having a degree of hydrolysis between 70% and 90%.

2) Acrylic Polymer

The term “acrylic polymers” according to the present invention preferably means homopolymers or copolymers of acrylic acid with C₁-C₃₀ alkyl acrylates either not cross linked or cross linked with polyalkenyl polyethers.

Although acrylic acid is the most common primary monomer for producing polyacrylic acid, the term “acrylic acid” according to the present invention means generically all unsaturated alpha-beta monomers substituted with carboxylic groups or dicarboxylic acid anhydrides.

Various polyunsaturated monomers are usable for generating a three-dimensional structure whether partially or substantially cross linked. Cross linked monomers include, for example, allyl ethers of saccharose or pentaerythritol, or similar compounds, diallyl esters, dimethallyl ethers, allyl or methallyl acrylates, and acrylamides, tetraallyltin, tetravinyl silanes, polyalkenyl methanes, diacrylates and dimethacrylates, divinyl compounds such as divinylbenzene, divinyl glycol, polyallyl phosphate, diallyloxy compounds, phosphite esters and the like. Typical of said polyunsaturated monomers are di, tri or tetra, penta, or hexaallyl saccharose; di, tri or tetra allyl pentaerythritol; diallyl phthalate, diallyl itaconate, diallyl fumarate, diallyl maleate, divinylbenzene, allyl methacrylate, allyl citrate, ethylene glycol di(meth)acrylate, trimethylolpropane triacrylate, 1,6-hexanediol diacrylate, pentaerythritol triacrylate, tetramethylene diethacrylate, tetramethylene diacrylate, ethylene diacrylate, ethylene dimethacrylate, triethylene glycol methacrylate, methylene bis acrylamide, and the like. Preferred cross linking agents include allyl pentaerythritol, allyl saccharose, trimethylolpropane allyl ether and divinyl glycol.

3) Polymeric Plasticizer

It is preferable to add to the suspending system A a further compatibilizer belonging to the polymeric plasticizer class.

The polymeric plasticizers which are useful for the purposes of this invention preferably include polymers with average molecular weight between 800 and 8000.

The use of a polymeric plastcizer allows to obtain a suspending system A which is not powdery and with excellent handling and water dispersion characteristics. The wide range of polymeric plasticizers include the reaction products of common C₄-C₁₂ carboxylic diacids with C₂-C₁₀ glycols terminating with C₆-C₂₀ acids or monofunctional alcohols.

Preferably, the polymeric plasticizers used in the present invention are selected from the group consisting of benzoate polymers, adipate polymers, glutarate polymers, sebacate polymers and phthalate polymers, among which adipate polymers are particularly preferred.

The composition for suspending system A of the present invention is prepared by directly mixing the aforesaid components.

The suspending system A is prepared by dissolving the aforesaid composition, that is a free-flowing powder, in deionised water. Preferably, the dissolution is carried out at a temperature of 30±5° C. within standard dissolution reactors, while maintaining the mixture under stirring for 3 hours to enable complete dissolution. Solutions of the aforesaid composition are obtained having a concentration of preferably between 2% and 8% and even more preferably between 3% and 5%.

To sum up, as pointed out above, the present invention relates therefore to a powder composition A comprising:

a) from 60% to 90% of at least one polyvinyl alcohol having a degree of hydrolysis between 25 and 98%; and

b) from 2% to 15% of an acrylic polymer.

Preferably in the said powder composition A, said polyvinyl alcohol has a degree of hydrolysis between 70% and 90%.

Preferably, in the said powder composition A, irrespective of the particular grade of hydrolysis of the polyvinyl alcohol as above, said acrylic polymer is selected from the group consisting of homopolymers or copolymers of acrylic acid with C₁-C₃₀ alkyl acrylates either not cross linked or cross linked with polyalkenyl polyethers.

In any case, the powder composition A, may preferably further comprise between 2% and 10% of at least one polymeric plasticizer.

Preferably, the said powder composition A may comprise from 3% to 5% of the said polymeric plasticizer.

More preferably, said polymeric plasticizer has an average molecular weight between 800 and 8000, and it is still more preferably selected from the group consisting of benzoate polymers, adipate polymers, glutarate polymers, sebacate polymers and phthalate polymers. Most preferably, the said polymeric plasticizer is an adipate polymer.

The present invention also relates to a suspending system obtained by dissolving in water the said composition A as defined in the aforementioned summary. Preferably, the said suspension-system has a concentration between 2% and 8%, more preferably between 3% and 5%.

The present invention also refers to a composition, suitable for preparing the aforesaid suspending system B, comprising at least one suspending agent belonging to the class of polyvinyl alcohols with degree of hydrolysis between 25% and 70% and a hydrotalcite compound of formula (1) as described above. A further aspect of the present invention is a suspending system, known as suspending system B, obtained from the aforesaid composition. Preferably said suspending system is a water/methanol dispersion containing between 7% and 18% of the hydrotalcite compound and between 5% and 15% of polyvinyl alcohol. In the hydrotalcite compounds used for the purposes of the invention, in formula (1), Aⁿ⁻ preferably represents an anion selected preferably from the group consisting of CO₃²⁻, HCO₃⁻, ClO₄⁻, SiO₃²⁻, an acetate ion, a salicylate ion, a tartrate ion, a citrate ion, [Fe(CN)₆]⁴⁻, NO³⁻, I⁻; (OOC—COO)²⁻.

Among the aforesaid anions CO₃²⁻ is particularly preferred.

The hydrotalcites of formula (I) and the methods for their production are well known, many of these compounds being commercially available.

The hydrotalcite compounds of the present invention have a particle size suitable for achieving their dispersion in micro-emulsion. In particular, said compounds preferably have a crystallite dimension between 200 and 1500 Å, more preferably between 500 and 1000 Å. This crystallite dimension is obtained by means of particular co-precipitation methods and hydrothermal treatments between 150° C. and 250° C. used for obtaining the stabilizer (examples 1 and 2).

In particular, in the suspending system B the polyvinyl alcohol enables a hydroalcoholic suspension to be obtained in which the hydrotalcite type compound is present in microdispersed form; the suspending system B is therefore compatible with the suspending system A described in the present invention and with the common catalytic systems currently used for preparing S-PVC.

As will be demonstrated in the following examples, mixes prepared with the PVC of the present invention display an initial colour and colour fastness that are significantly better than those of both non-stabilized mixes and mixes in which the addition of the stabilizer takes place during manufacture.

Evaluation of the efficiency of the polymerisation reaction when employing the modified suspending system as described in the present invention, has been tested in the different series of trials reported hereinafter, which were carried out in a pilot plant.

To sum up, as pointed out above, the present invention relates therefore to a powder composition B comprising a polyvinyl alcohol having a degree of hydrolysis between 25% and 70% and a hydrotalcite compound of formula (I):
[M²⁺₁₋ₓM³⁺ₓ(OH)]^{x+}(Aⁿ⁻_{x/n}).mH₂O (1)
wherein:
M²⁺ represents at least one divalent metal cation selected from the group consisting of Mg, Ca, Sr, Ba, Zn, Co, Mn and Ni;
M³⁺ represents at least one trivalent metal cation selected from the group consisting of Al, B, Bi and Fe;
Aⁿ⁻ is an anion having a valency from 1 to 4;
x and m represent positive numbers satisfying the following expressions
0.2<x≦0.33
m>0.

Preferably, in the said composition B, said hydrotalcite type compounds of formula (1), Aⁿ⁻ represents an anion selected from the group consisting of CO₃²⁻, HCO₃⁻, ClO₄⁻, SiO₃²⁻, an acetate ion, a salicylate ion, a tartrate ion, a citrate ion, [Fe(CN)₆]⁴⁻, N³⁻; I⁻ and (OOC—COO)²⁻.

Particularly preferred is a composition B, wherein in said hydrotalcite compound of formula (1), Aⁿ⁻ is CO₃²⁻.

Still more preferably, in the said composition B, said hydrotalcite compound has a crystallite dimension between 200 and 1500 Å.

Most preferably, in the said composition B, said hydrotalcite compound has a crystallite dimension between 500 and 1000 Å.

Preferably, in the aforementioned cases, irrespective of the particular hydrotalcite compound employed, said polyvinyl alcohol has a degree of hydrolysis between 35% and 55%, more preferably between 40% and 50%.

The present invention also relates to a suspending system obtained by dissolving in water the said composition B as defined in the aforementioned summary.

Preferably, such suspending system consists of a water/methanol dispersion containing from 7% to 18% of a hydrotalcite compound and from 5% to 15% of polyvinyl alcohol.

### EXAMPLE 1

### Preparation of Hydrotalcite Compounds

A) 60 litres of demineralised water, 5.5 kg of Mg(OH)₂ and 3 kg of Al(OH)₃ are fed into a 100 litre stainless steel reactor at t=25° C. While maintaining the mixture under stirring, an overpressure is created by introducing 2.2 kg of CO₂, then the mixture is heated to an internal temperature of 180° C. (Pₘₐₓ=10 bar). The mixture is maintained at this temperature for 4 hours. After cooling the walls of the reactor are washed with water, and 75 kg of aqueous hydrotalcite emulsion are loaded.

Characteristics:

pH of the suspension=7±0.7

dry titre (hygrometric balance at 150° C.)=14%

B) 60 litres of demineralised water, 4.2 kg of Mg(OH)₂, 3 kg of Al(OH)₃ and 0.95 kg of ZnO are fed into a 100 litre stainless steel reactor at t=25° C. While maintaining the mixture under stirring, an overpressure is created by introducing 2.5 kg of CO₂, then the mixture is heated to an internal temperature of 180° C. (Pₘₐₓ=10 bar). The mixture is maintained at this temperature for 6 hours. After cooling the reactor walls are washed with water, 75 kg of aqueous hydrotalcite emulsion are fed in.

pH of the suspension=6.9±0.7

dry titre (hygrometric balance at 150° C.)=12.5%.

Preparation of Suspending System B

C) The hydrotalcite aqueous emulsions prepared in examples 1A) and 1B) are treated with methanol (0.5 volumes per weight of emulsion) at ambient temperature while maintaining the mixture under agitation; the mixture is then filtered to obtain a 30% mixture of hydrotalcite in hydroalcoholic suspension.

The aforesaid mixture is added to a solution in methanol containing 40% by weight PVA having a degree of hydrolysis of 45%

A modified suspending system is obtained consisting of 7% polyvinyl alcohol with a degree of hydrolysis of 45%, and 9% hydrotalcite compound stabilizer.

### EXAMPLE 2

S-PVC with a value of K57 was prepared by polymerisation of the vinyl chloride monomer in the absence of stabilizer (sample S or A1) or by using as stabilizer the hydrotalcite of formula Al₂Mg_{4.5}(OH)₁₃CO₃.xH₂O produced in Example 1A) (samples A2-A3).

The polymerisation reaction was conducted by using standard primary (SP S) and secondary (SS S) suspending systems and/or suspending systems A and/or B in accordance with the invention.

In particular, suspending systems having % the following compositions were used:
standard primary suspending system (SP S):
   25% PVA with a degree of hydrolysis of 88%
   75% PVA with a degree of hydrolysis of 72%
standard secondary suspending system (SS S):
   100% of a 40% methanol solution of PVA with a degree of hydrolysis of 42%
suspending system A:
   20% of PVA with 88% degree of hydrolysis;
   70% PVA with 72% degree of hydrolysis;
   6% acrylic polymer
   4% polymeric plasticizer.
suspending system B: as given in example IC).

In the reaction of polymerisation the quantities of stabilizer, standard (S) primary (SP) or secondary (SS) suspending agents, or suspending system A and B according to the invention are given in table 1, expressed in ppm (parts per million) with respect to the quantity of vinyl chloride monomer fed in.

TABLE 1

| | | | S | A1 | A2 | A3 |
|---|---|---|---|---|---|---|
| SP S | | | 830 | 415 | | |
| SS S | | | 630 | 630 | 315 | |
| A | | | | 415 | 830 | 830 |
| | B | suspending agent | | | 315 | 630 |
| | | stabilizer | | | 300 | 600 |

All the most important parameters for evaluating the efficiency of the reaction and the quality of the S-PVC obtained are given in table 2:

TABLE 2

| | | | | | | | fish-eyes |
|---|---|---|---|---|---|---|---|
| | final pH | % conv | KV | % H2O | CPA | BD kg/m3 | number |
| S | 2.7 | 82.5 | 56.8 | 17.1 | 14.8 | 527 | 1.0 |
| A1 | 2.8 | 84.0 | 56.8 | 16.6 | 20.6 | 521 | 2.0 |
| A2 | 3.8 | 84.6 | 56.8 | 16.5 | 16.9 | 535 | 0 |
| A3 | 6.8 | 83.7 | 57.0 | 13.6 | 14.4 | 547 | 0 |

The conversion and K value parameters obtained highlight the absolute reproducibility of the innovative process compared to the established one. The pH value found at the reaction end point in example S indicates the formation of hydrochloric acid during polymerisation. Normally this phenomenon is compensated for by adding buffering systems (sodium bicarbonate, ammonium bicarbonate, tricalcium phosphate etc.) which are scarcely safe and are often detrimental to the efficiency of the suspending agents.

The values obtained in the comparative trials show a reduction of free chloride ions in the system at reaction end point. This aspect is highly evident in comparative example A3 where the pH value is practically neutral.

With regard to the morphology of the polymer obtained with the new modified uspension system, a slight reduction in the cold plasticizer absorption value (CPA) and in the percentage of water present in the cake prior to centrifugation and drying, and an increase in the bulk density value (BD) are observed. These data demonstrate that the new suspending system results in a S-PVC with excellent porosity and apparent density characteristics. Another parameter which confirms the excellent characteristics from the processing view point, is the almost complete absence of fish-eyes (fish-eyes number).

Particle size distribution is reported, in table 3, wherein in particular D50 indicates the average dimensions of a particle while D10 and D90 indicate the distribution of the extreme fractions.

TABLE 3

| | D50 μm | D10 μm | D90 μm |
|---|---|---|---|
| S | 137 | 96 | 192 |
| A1 | 126 | 83 | 185 |
| A2 | 142 | 91 | 221 |
| A3 | 139 | 90 | 207 |

Also these values confirm the absolute reproducibility of the new process compared with the established one.

### EXAMPLE 3

S-PVC with a value of K57 was prepared by polymerisation of the vinyl chloride monomer using as stabilizer the hydrotalcite of formula Al₂Mg_{4.5}(OH)₁₃CO₃.xH₂O produced as in Example 1A) (samples A4-A7) or the hydrotalcite of formula Al₂Mg_{3.5}Zn(OH)₁₃CO₃.xH₂O produced as in example 1B) (A8-A9).

The polymerisation reaction was conducted in the absence of stabilizer and in the presence of primary and secondary traditional suspending systems (sample S) or in the presence of the stabilizer and of suspending systems A and B according to the present invention. In particular, the suspending systems used had the same composition of those of example 2.

The quantities of stabilizer, of standard (S) primary (SP) and secondary (SS) suspending agents, or suspending systems A and B used according to the invention, expressed in ppm (parts per million) which respect to the amount of vinyl chloride monomer quantity fed in, are given in table 4:

TABLE 4

| | | S | A4 | A5 | A6 | A7 | A8 | A9 |
|---|---|---|---|---|---|---|---|---|
| SP S | | 830 | | | | | | |
| SS S | | 630 | | | | | | |
| A | | | 750 | 750 | 750 | 750 | 750 | 750 |
| B | suspending agent | | 600 | 600 | 600 | 600 | 600 | 600 |
| | stabilizer 1¹ | | 600 | 1200 | 1800 | 2400 | | |
| | stabilizer 2² | | | | | | 1200 | 1800 |

¹as in example A
²as in example B

The data given in table 5 again highlight the absolute reproducibility of the modified process:

TABLE 5

| | | | | | | | | | | | | | Poly- | |
|---|---|---|---|---|---|---|---|---|---|---|---|---|---|---|
| | D50¹ | D10² | D90³ | BD⁴ | final | | | | | | | number of | time⁸ | |
| | (μm) | (μm) | (μm) | (kg/m3) | pH | conv %⁵ | % H₂O⁶ | KV | L*⁷ | a*⁷ | b*⁷ | fish-eyes | (min) | CPA⁹ |
| T | 137 | 96 | 192 | 527 | 2.7 | 82.5 | 17.1 | 56.8 | 99 | 0.46 | 1.33 | 1 | 300 | 14.8 |
| A4 | 143 | 90 | 224 | 535 | 6.5 | 82 | 14.3 | 56.8 | 99.5 | 0.48 | 1.31 | 1.5 | 300 | 17.2 |
| A5 | 140 | 95 | 215 | 537 | 6.6 | 83 | 13.9 | 56.5 | 99.3 | 0.45 | 1.25 | 1 | 300 | 14.5 |
| A6 | 139 | 90 | 203 | 538 | 6.6 | 82.5 | 16.7 | 56.5 | 99.3 | 0.48 | 1.32 | 1 | 300 | 16.7 |
| A7 | 136 | 91 | 205 | 534 | 6.5 | 81 | 15.8 | 56.7 | 99.5 | 0.43 | 1.21 | 1 | 310 | 15.4 |
| A8 | 141 | 92 | 196 | 533 | 6.1 | 82.5 | 14.4 | 56.9 | 99.6 | 0.4 | 1.26 | 0 | 300 | 14.7 |
| A9 | 142 | 93 | 219 | 530 | 5.9 | 80 | 15.9 | 56.9 | 99.5 | 0.26 | 1 | 1 | 320 | 17 |

¹average particle diameter
²minimum particle diameter
³maximum particle diameter
⁴apparent density
⁵conversion percentage
⁶percentage of water in the cake prior to centrifugation
⁷L variable luminosity; a, b chromaticity co-ordinates
⁸time between moment when product achieves polymerisation temperature and moment of introduction of terminator radical
⁹cold plasticizer absorption

### EXAMPLE 4

In order to evaluate the behaviour of S-PVC obtained by the production method of the present invention, from the viewpoint of intrinsic thermal stability mixes were prepared by homogeneously mixing the resin with a lubricant in the amounts indicated in table 6, expressed in parts by weight per 100 parts by weight of PVC:

TABLE 6

| | 1 | 2 | 3 | 4 | 5 | 6 | 7 | 8 | 9 | 10 |
|---|---|---|---|---|---|---|---|---|---|---|
| S-PVC S | 100 | | | | | | | | | |
| S-PVC A1 | | 100 | | | | | | | | |
| S-PVC A2 | | | 100 | | | | | | | |
| S-PVC A3 | | | | 100 | | | | | | |
| S-PVC A4 | | | | | 100 | | | | | |
| S-PVC A5 | | | | | | 100 | | | | |
| S-PVC A6 | | | | | | | 100 | | | |
| S-PVC A7 | | | | | | | | 100 | | |
| S-PVC A8 | | | | | | | | | 100 | |
| S-PVC A9 | | | | | | | | | | 100 |
| RL/216¹ | 0.3 | 0.3 | 0.3 | 0.3 | 0.3 | 0.3 | 0.3 | 0.3 | 0.3 | 0.3 |

¹oxidised polyethylene wax

With regard to intrinsic thermal stability of the polymer obtained, static thermal stability tests were carried out on the non-stabilized resin using an oxidised polyethylene wax as lubricant to facilitate sample preparation within the cylinder mixer.

Rectangular samples (1.5×24 cm) were cut out of each sheet (whose thickness is 0.3-0.5). The samples were fixed onto the sliding carriage of a Werner Mathis dynamic oven, temperature controlled at 180° C. and subjected to heating. The carriage left the oven at a speed of 1 cm per minute at 180° C.

The results obtained, given in FIG. 1, show that the stabilizing effect is evident. The mixes prepared with S-PVC obtained with the procedure of the present invention (2-10) display an initial colour and a colour fastness which is better than that of the mix prepared with non pre-stabilized S-PVC (1). The stabilizer dose (varying from 600 to 2400 ppm) significantly influences the colour.

Moreover, retention of initial colour is particularly evident in the S-PVCs pre-stabilized with the hydrotalcite containing zinc (example B preparation).

Thermal stability was also determined by measuring the value of Congo red (CR). The Congo red was obtained in accordance with standard DIN VDE 0472(614), measuring the time employed to obtain the colour change of a indicator paper placed at the top of a test tube containing 50 mg of a PVC sample obtained from the sheet and temperature controlled at 180° C.

Table 7 shows the values obtained, which again highlight the effect of stabilizer dose on the effectiveness of pre-stabilizabon:

TABLE 7

| | 1 | 2 | 3 | 4 | 5 | 6 | 7 | 8 | 9 | 10 |
|---|---|---|---|---|---|---|---|---|---|---|
| CR | 2 | 3 | 3 | 4 | 5 | 6 | 8 | 10 | 7 | 10 |

### EXAMPLE 5

In order to evaluate the effect of pre-stabilization and the interaction with stabilizing systems that are normally used in industry during manufacture, sheets of samples were prepared according to the following methods. Mixes were prepared using the various samples of S-PVC obtained with the method of the present invention and a stabilizing system based on calcium and zinc derivatives, Reapak B AV2116/1 marketed by Reagens, homogeneously mixing the components in the amounts expressed in parts by weight per 100 parts by weight of PVC, indicated in table 8:

TABLE 8

| | 11 | 12 | 13 | 14 |
|---|---|---|---|---|
| S-PVC S | 100 | | | |
| S-PVC A3 | | 100 | | |
| S-PVC A5 | | | 100 | |
| S-PVC AS | | | | 100 |
| REAMOD 550¹ | 6 | 6 | 6 | 6 |
| OMYA 95T² | 6 | 6 | 6 | 6 |
| TiO2 CL2220 | 4 | 4 | 4 | 4 |
| REAPAK B-AV/2116/1 | 4 | 4 | 4 | 4 |

¹high impact acrylic marketed by Reagens
²calcium carbonate marketed by Omya

The blends were gelled for 4 minutes at 180° C. in a calendar.

The sheets obtained were subjected to the static thermal stability test.

The carriage left the oven at a speed of 0.5 cm every 90 seconds at 190° C.

At successive 10 minute intervals the chromatic difference was measured in the Lab calorimetric space as a single numerical value expressed by DE:
DE=[(DL)²+(Da)²+(Db)²]^{1/2}
where L is variable luminosity, a and b are the chromaticity co-ordinates and DL, Da, Db are the differences, of L, a, b respectively, can be deduced between the final state and the initial state at time zero.

From the results obtained, shown in FIGS. 3 and 4, it can be deduced that the initial colour, thermal stability and colour fastness are significantly better in the samples containing the S-PVC produced with the process of the present invention (mixes 12-14 and 16-18), compared with the samples containing non pre-stabilized S-PVC (mix 11).

The determination of thermal stability to Congo red also confirms the results obtained, as seen in table 9:

TABLE 9

| | 11 | 12 | 13 | 14 |
|---|---|---|---|---|
| CR | 17 | 18 | 19 | 19 |

### EXAMPLE 6

Mixes of compositions indicated in table 10 were prepared using the tin-based stabilizing system Reatinor 847, marketed by Reagens.

TABLE 10

| | 15 | 16 | 17 | 18 |
|---|---|---|---|---|
| SPVC S | 100 | | | |
| SPVC A3 | | 100 | | |
| S-PVC A5 | | | 100 | |
| S-PVC A8 | | | | 100 |
| BTA 736¹ | 6 | 6 | 6 | 6 |
| epoxidised soya oil | 3 | 3 | 3 | 3 |
| REATINOR 847² | 3 | 3 | 3 | 3 |

¹high impact methacrylate butadiene styrene
²dioctyltin 2-ethylhexyl thioglycolate

The blends were gelled for 4 minutes at 180° C. in a calendar.

A thermal stability test in this case was also carried out with the carriage leaving the oven at a speed of 0.5 cm every 2 minutes at 190° C.; the colour difference value was then measured at successive 10 minute intervals. From the results obtained, given in graph 2 (FIG. 3), the important improvement gained by the use of pre-stabilized S-PVC can once more be observed.

Determination of thermal stability to Congo red also confirms the results obtained, as seen in table 11:

TABLE 11

| | 15 | 16 | 17 | 18 |
|---|---|---|---|---|
| CR | 25 | 27 | 30 | 28 |

### EXAMPLE 7

Since hydrotalcites are compounds normally used for stabilizing S-PVC, in order to emphasize that using S-PVC, obtained with the process of the present invention, leads to a different result from that obtained by using standard S-PVC to which a hydrotalcite has been added as stabilizer in a quantity equivalent to that added during polymerisation, mixes were prepared having compositions as shown in tables 12 and 13:

TABLE 12

| | 19 | 20 | 21 | 22 | 23 |
|---|---|---|---|---|---|
| S-PVC S | 100 | 100 | | 100 | |
| S-PVC A5 | | | 100 | | |
| S-PVC A8 | | | | | 100 |
| ALCAMIZER 1¹ | | 0.12 | | | |
| ALCAMIZER 4² | | | | 0.12 | |
| REAMOD 550 | 6 | 6 | 6 | 6 | 6 |
| OMYA 95T | 6 | 6 | 6 | 6 | 6 |
| TiO2 CL2220 | 4 | 4 | 4 | 4 | 4 |
| REAPAK BAV/2116/1 | 4 | 4 | 4 | 4 | 4 |

¹hydrotalcite supplied by Kyowa
²hydrotalcite supplied by Kyowa

TABLE 13

| | 24 | 25 | 26 |
|---|---|---|---|
| S-PVC S | 100 | 100 | |
| S-PVC A5 | | | 100 |
| ALCAMIZER 4¹ | | 0.12 | |
| BTA736² | 6 | 6 | 6 |
| epoxidised soya oil | 3 | 3 | 3 |
| REATINOR 847A | 3 | 3 | 3 |

¹hydrotalcite supplied by Kyowa
²high impact methacrylate butadiene styrene

The mixes were gelled for 4 minutes at 180° C. in a cylinder mixer. A thermal stability test in this case also was also carried out with the carriage leaving the oven at a speed of 0.5 cm every 90 seconds for samples 12-23. The chromatic difference value, obtained at successive 10 minute intervals, was measured.

For the thermal stability test of samples 24-26 the carriage left the oven at a speed of 0.5 cm every 2 minutes.

The results obtained, given in FIGS. 5, 6 and 7, show that the mixes (21, 23, 26) prepared using S-PVC of the present invention display an initial colour and a colour fastness significantly better than either the non pre-stabilized mixes (19, 24) or those (20, 22, 25) in which the addition of stabilizer occurs during manufacture. The Congo red values for the two series of trials are given in tables 14 and 15.

TABLE 14

| | 19 | 20 | 21 | 22 |
|---|---|---|---|---|
| CR | 16 | 18 | 19 | 18 |

TABLE 15

| | 23 | 24 | 25 | 26 |
|---|---|---|---|---|
| CR | 17 | 20 | 24 | 26 |

From the data it can be deduced that the subsequent addition of equivalent quantities of hydrotalcite to non-stabilized S-PVC does not confer the same thermal stabilizing effect as that obtained by in situ stabilization.

1. A process for preparing S-PVC in aqueous suspension wherein the polymerisation reaction of the monovinyl chloride is conducted in the presence of:
a) a suspending system A comprising at least one polyvinyl alcohol having a degree of hydrolysis between 25% and 98% and an acrylic polymer; and
b) a suspending system B comprising at least one polyvinyl alcohol having a degree of hydrolysis between 25% and 70% and a hydrotalcite compound of formula (I):
[M²⁺₁₋ₓM³⁺ₓ(OH)]^{x+}(Aⁿ⁻_{x/n}).mH₂O (1)
wherein:
M²⁺ represents at least one divalent metal cation chosen from the group consisting of Mg, Ca, Sr, Ba, Zn, Co, Mn and Ni;
M³⁺ represents at least one trivalent metal cation chosen from the group consisting of Al, B, Bi and Fe;
Aⁿ⁻is an anion having a valency from 1 to 4;
x and m represent positive numbers satisfying the following expressions
0.2<x≦0.33
m>0.

2. The process as claimed in claim 1, comprising the following steps: I) treating with an alcohol, under stirring at ambient temperature said hydrotalcite compound of formula (1) in aqueous suspension, then filtering the mixture obtained to obtain a hydrotalcite paste in hydroalcoholic solution; II) adding the paste derived from step I) under stirring to a solution in methanol of polyvinyl alcohol with a degree of hydrolysis between 25% and 70%, to obtain said suspending system B; (III) adding said suspending system B obtained in step II) under stirring to said suspending system A.

3. The process as claimed in claim 2, wherein in step I) said alcohol is selected from the group consisting of methanol, ethanol, propanol and isopropanol.

4. The process as claimed in claim 2, wherein in step I) said alcohol is methanol.

5. The process as claimed in claim 2 wherein the paste obtained in step I) contains an amount of said hydrotalcite compound of 25-35% by weight.

6. The process as claimed in claim 2 wherein the paste obtained in step I) contains an amount of said hydrotalcite compound of 27-32% by weight.

7. The process as claimed in claim 2 wherein in step II) said solution of polyvinyl alcohol in methanol has a concentration between 20 and 60%.

8. The process as claimed in claim 2 wherein in step II) a suspending system B is obtained containing from 7% to 18% of hydrotalcite compound and from 5% to 15% of polyvinyl alcohol.

9. The process as claimed in claim 2 wherein in step III) said suspending system A has a concentration between 2% and 8%.

10. The process as claimed in claim 2 wherein in step III) said suspending system A has a concentration between 3% and 5%.

11. The process as claimed in claim 1 wherein said polymerisation reaction is conducted in the presence of a concentration, expressed in parts per million with respect to the amount of vinyl chloride monomer, of between 400 and 1500 ppm of said polyvinyl alcohol of suspending system A, between 600 and 1800 ppm of said polyvinyl alcohol of suspending system B and between 500 and 2500 ppm of said hydrotalcite compound of formula 1).

12. The process as claimed in claim 11 wherein said polymerisation reaction is conduced in the presence of a concentration, expressed in parts per million with respect to the amount of the vinyl chloride monomer, of between 600 and 1000 ppm of said polyvinyl alcohol of suspending system A, between 600 and 1200 ppm of said polyvinyl alcohol of suspending system B and between 800 and 1400 ppm of said hydrotalcite compound of formula 1).

13. The process as claimed in claim 1 wherein said polyvinyl alcohol of suspending system B has a degree of hydrolysis between 35% and 55%.

14. The process as claimed in claim 13, wherein said polyvinyl alcohol has a degree of hydrolysis between 40% and 50%.

15. The process as claimed in claim 1 wherein the polyvinyl alcohol in said suspending system A has a degree of hydrolysis between 70% and 90%.

16. The process as claimed in claim 1 wherein the acrylic polymer in said suspending system A is selected from the group consisting of homopolymers or copolymers of acrylic acid with C₁-C₃₀ alkyl acrylates either not cross linked or cross linked with polyalkenyl polyethers.

17. The process as claimed in claim 1 wherein in said hydrotalcite compound of formula (1), Aⁿ⁻ represents an anion selected from the group consisting of CO₃²⁻, HCO₃⁻, ClO₄⁻, SiO₃²⁻, an acetate ion, a salicylate ion, a tartrate ion, a citrate ion, [Fe(CN)₆]⁴⁻, NO³⁻, I⁻ and (OOC—COO)²⁻.

18. The process as claimed in claim 17 wherein in said hydrotalcite compound of formula (I), Aⁿ⁻ is CO₃²⁻.

19. The process as claimed in claim 1 wherein said hydrotalcite compound of formula (I) has a crystallite dimension between 200 and 1500 Å.

20. The process as claimed in claim 19 wherein said hydrotalcite compound has a crystallite dimension between 500 and 1000 Å.

21. The process as claimed in claim 1 wherein said suspending system A further comprises a polymeric plasticizer.

22. The process as claimed in claim 21 wherein said polymeric plasticizer has an average molecular weight between 800 and 8000.

23. The process as claimed in claim 22 wherein said polymeric plasticizer is selected from the group consisting of benzoate polymers, adipate polymers, glutarate polymers, sebacate polymers and phthalate polymers.

24. The process as claimed in claim 23 wherein said polymeric plasticizer is an adipate polymer.

25. A process for preparing a suspending system employed in the preparation of S-PVC in aqueous suspension comprising the step of using a powder composition comprising:
a) from 60% to 90% of at least one polyvinyl alcohol having a degree of hydrolysis between 25 and 98%; and
b) from 2% to 15% of an acrylic polymer.

26. The process as claimed in claim 25 wherein said polyvinyl alcohol comprised by said powder composition has a degree of hydrolysis between 70% and 90%.

27. The process as claimed in claim 25 wherein said acrylic polymer comprised by said powder composition is selected from the group consisting of homopolymers or copolymers of acrylic acid with C₁-C₃₀ alkyl acrylates either not cross linked or cross linked with polyalkenyl polyethers.

28. The process as claimed in claim 25, wherein the said powder composition further comprises between 2% and 10% of at least one polymeric plasticizer.

29. The process as claimed in claim 28 wherein the said powder composition comprises from 3% to 5% of polymeric plasticizer.

30. The process as claimed in claim 28 wherein said polymeric plasticizer comprised by said powder composition has an average molecular weight between 800 and 8000.

31. The process as claimed in claim 30 wherein said polymeric plasticizer comprised by said powder composition is selected from the group consisting of benzoate polymers, adipate polymers, glutarate polymers, sebacate polymers and phthalate polymers.

32. The process as claimed in claim 31 wherein said polymeric plasticizer comprised by said powder composition is an adipate polymer.

33. A process for preparing S-PVC comprising the step of using a suspending system obtained by dissolving in water a composition as defined in claims.

34. The process as claimed in claim 33 wherein said suspending system has a concentration between 2% and 8%.

35. The process as claimed in claim 34 wherein said suspending system has a concentration is between 3% and 5%.

36. A process for preparing a suspending system employed in the preparation of S-PVC in aqueous suspension comprising the step of using a composition comprising a polyvinyl alcohol having a degree of hydrolysis between 25% and 70% and a hydrotalcite compound of formula (I):
[M²⁺₁₋ₓM³⁺ₓ(OH)]^{x+}(Aⁿ⁻_{x/n}).mH₂O (1)
wherein:
M²⁺ represents at least one divalent metal cation selected from the group consisting of Mg, Ca, Sr, Ba, Zn, Co, Mn and Ni;
M³⁺ represents at least one trivalent metal cation selected from the group consisting of Al, B, Bi and Fe;
Aⁿ⁻ is an anion having a valency from 1 to 4;
x and m represent positive numbers satisfying the following expressions
0.2<x≦0.33
m>0,

37. The process as claimed in claim 36 wherein in said hydrotalcite type compounds of formula (1) comprised by said composition, Aⁿ⁻ represents an anion selected from the group consisting of CO₃²⁻, HCO₃⁻, ClO₄⁻, SiO₃²⁻, an acetate ion, a salicylate ion, a tartrate ion, a citrate ion, [Fe(CN)₆]⁴⁻, NO³⁻, I⁻ and (OOC—COO)²⁻.

38. The process as claimed in claim 37 wherein in said hydrotalcite compound of formula (1), Aⁿ⁻ is CO₃²⁻.

39. The process as claimed in claim 36 wherein said hydrotalcite compound comprised by said composition has a crystallite dimension between 200 and 1500 Å.

40. The process as claimed in claim 39 wherein said hydrotalcite compound comprised by said composition has a crystallite dimension between 500 and 1000 Å.

41. The process as claimed in claim 36 wherein said polyvinyl alcohol comprised by said composition has a degree of hydrolysis between 35% and 55%.

42. The process as claimed in claim 41 wherein said polyvinyl alcohol comprised by said composition has a degree of hydrolysis between 40% and 50%.

43. A process for preparing S-PVC comprising the step of using a suspending system obtained from a composition as mentioned in claims 36.

44. The process as claimed in claim 43, said suspending system consisting of a water/methanol dispersion containing from 7% to 18% of a hydrotalcite compound and from 5% to 15% of polyvinyl alcohol.
